(19) United States
(12) Patent Application Publication
(10) Pub. No.: US 2014/0374558 A1
(43) Pub. Date: Dec. 25, 2014

(54) Apparatus for Hanging Up and Supporting Weighted Objects

(71) Applicants: William Elbert Devin, Capistrano Beach, CA (US); Kevin John Waggoner, San Clemente, CA (US)

(72) Inventors: William Elbert Devin, Capistrano Beach, CA (US); Kevin John Waggoner, San Clemente, CA (US)

(21) Appl. No.: 13/923,192

(22) Filed: Jun. 20, 2013

(51) Int. Cl. F16M 13/00

(52) U.S. Cl. CPC F16M 13/00
USPC 248/317

(57) ABSTRACT

Provided herein is a hanging apparatus for hanging up and supporting a weighted object; the apparatus comprising a central support piece comprising: a hanging device, an anchoring device, an aperture; and a cord lock system; wherein the apparatus is capable of hanging up and supporting a weighted object when an elongate cord is attached to an anchoring device, returned through the aperture, secured in the cord lock system, and looped around the weighted object.

### FIELD OF THE INVENTION

The present invention relates to the field of apparatuses for providing tensioning or tensile strength such as for hanging up and supporting objects. Such apparatuses are typically designed for organizational and/or storage purposes but can also by adapted for adjusting and tensioning cords such as used in, for example, volleyball nets, or venetian blinds; and/or for tensioning and locking a cord, such as used for a tent, or a tarp.

### BACKGROUND OF THE DISCLOSURE

It is generally always desirable in the organizational and storage system field, to keep weighted objects off the floor to eliminate clutter and free up available floor space. This is especially true in areas designated for storage purposes such as closets, workshops, garages, sheds, basements, attics, pantries, warehouses, construction sites, or any such room, space or area designated for storage purposes. In such areas, weighted objects, often difficult to hang, are usually stored.

While hanging apparatuses are readily available and may be found, for example, in U.S. Pat. No. 6,330,949; U.S. Pat. No. 7,346,962; and US 2012/0311824; none of these references disclose the embodiments of the present invention.

In addition, cleats and cleat-like devices of varying designs, sizes and shapes are readily available and may be found, for example in U.S. Pat. No. 4,956,897; U.S. Pat. No. 5,220,709; U.S. Pat. No. 5,307,751; U.S. Pat. No. 5,519,921; U.S. Pat. No. 5,788,327; U.S. Pat. No. 5,784,979; U.S. Pat. No. 6,152,060; U.S. Pat. No. 6,604,482; US 2006/0283997; U.S. Pat. No. 7,513,207; and U.S. Pat. No. 8,321,998; however, none of these references disclose the embodiments of the present invention.

Therefore, a need exists in the art for a convenient and inexpensive apparatus which is capable of providing sufficient tensile strength for hanging up and supporting weighted objects. There also exists a need in the art for an effective organizational apparatus for hanging up and supporting objects; which does not require bulky wall-mounted support members; heavy gauge wires and/or multiple connection devices.

All documents and references cited herein and in the referenced patent documents, are hereby incorporated herein by reference.

### SUMMARY OF THE INVENTION

The present inventors have designed, constructed, and developed an innovative apparatus capable of providing sufficient tensile strength for hanging up and supporting a weighted object.

Disclosed herein is an apparatus for hanging up and supporting a weighted object; the apparatus comprising a central support piece comprising: a hanging device, an anchoring device, an aperture; and a cord lock system; wherein the apparatus is capable of hanging up and supporting a weighted object when an elongate cord is attached to an anchoring device, returned through the aperture, secured in the cord lock system, and looped around the weighted object.

In another embodiment, the apparatus further comprises an elongate cord, wherein the elongate cord is attached to the anchoring device and returned through the aperture.

In an additional embodiment, the elongate cord of the apparatus is secured in the cord lock system and looped around the weighted object.

In a further embodiment, the elongate cord of the apparatus is a non-elasticized elongate cord.

In an additional embodiment, the elongate cord of the apparatus is attached to the anchoring device via a knot. In a further embodiment, the knot is a buntline hitch.

In another embodiment, the hanging device of the apparatus is selected from the group consisting of a clip hook, an open hook, a closed hook, an eye hook, a swivel hanger, and a cord.

In another embodiment, the apparatus of the present invention is capable of hanging up and supporting a weighted object with a pound-mass up to about 150 pounds (lbs).

In another embodiment, the anchoring device of the apparatus is selected from the group consisting, of a tension pin, a swaged stop, and a swaged ferrule.

In another embodiment, the anchoring device of the apparatus is an indentation or a protrusion. In a further embodiment, the indentation or protrusion is molded into the central support piece of the apparatus.

In another embodiment, the anchoring device of the apparatus is a tension pin.

In an additional embodiment, the tension pin of the apparatus is an internal tension pin. In a further embodiment, the tension pin is a spring pin or a roll pin.

In another embodiment, the cord lock system of the apparatus is an external cord lock system.

In another embodiment, the cord lock system of the apparatus is selected from the group consisting of a notched groove lock, a cam lock, a wedge lock, a notched rod lock, a compression pin lock, an aperture binding lock, a swaged ferrule lock, and a sliding lock. In a certain embodiment, the cord lock system of the apparatus is a notched groove lock.

In another embodiment, the apparatus comprises a rounded protuberance at topside of the aperture. In a further embodiment, the rounded protuberance is molded onto the central support piece.

In another aspect of the present invention for hanging up and supporting a weighted object; the apparatus comprises a central support piece comprising: a hanging device, an anchoring device, an aperture; a cord lock, system; and an elongate cord; wherein the elongate cord is attached to the anchoring device; and wherein the apparatus is capable of hanging up and supporting a weighted object when the elongate cord is returned through the aperture, secured in the cord lock system and looped around the weighted object. In further embodiment, the elongate cord is returned through the aperture. In an additional embodiment, the elongate cord is secured in the cord lock system and looped around the weighted object.

In other embodiments, the apparatus in the preceding paragraph may additionally incorporate any of the preceding, or subsequent disclosed embodiments.

The Summary of the Invention is not intended to define the claims nor is it intended to limit the scope of the invention in any manner.

Other features and advantages of the invention will be apparent from the following Drawings, Detailed Description, and the Claims.

### BRIEF DESCRIPTION OF THE DRAWINGS

FIG. 1 shows an embodiment of the apparatus disclosed herein.

FIG. 2 illustrates an embodiment of the apparatus of the present invention showing a cord looped around a weighted object.

### DETAILED DESCRIPTION OF THE EMBODIMENTS

The present invention is illustrated in the drawings and description in which like elements are assigned the same reference numerals. However, while particular embodiments are illustrated in the drawings, there is no intention to limit the present invention to the specific embodiment or embodiments disclosed. Rather, the present invention is intended to cover all modifications, alternative constructions, and equivalents falling within the spirit and scope of the invention. As such, the drawings are intended to be illustrative and not restrictive.

Unless otherwise defined, all technical terms used herein have the same meaning as commonly understood by one of ordinary skill in the art to which this technology belongs.

The apparatus disclosed herein is capable of providing sufficient tensile strength for hanging, up and supporting a weighted object. The apparatus disclosed herein is also capable of providing sufficient tensioning or tensile strength for adjusting and tensioning cords and/or for tensioning and locking cords.

For the purposes of the present invention, the terminology “tensile strength” is generally known to the skilled artisan as the maximum measurement of the pulling force required to reach the ultimate stress or breaking point.

For the purposes of the present invention, a weighted object would he well known to the artisan in the field to be any object, item, or article, such as a consumer article, having a pound mass at least greater than the pound mass of the apparatus. In certain embodiments, the apparatus disclosed herein is capable of hanging up and supporting a weighted object with a pound-mass up to about 150 pounds (lbs). The term “about” refers to a +/−10% variation from the nominal value. Therefore, it is understood by those skilled in the art that the apparatus of the invention is capable of supporting a weighted object up to a pound-mass in the range of 135 lbs-165 lbs.

It is further appreciated by those skilled in the art that an apparatus of the present invention may be scaled up in size to accommodate a pound-mass greater than about 150 lbs. For example, an apparatus disclosed herein may be capable of hanging up and supporting weighted objects with a pound-mass up to about 200 lbs, 250 lbs, 300 lbs. or 350 lbs, and so on. Likewise, an apparatus of the present invention may be scaled down in size to better accommodate smaller weighted objects.

A weighted object may be any object, item, article, or consumer article, a user of the disclosed apparatus, desires to hang up and support. Weighted objects may be, but are not limited to, a fire extinguisher; machinery such as a lawn mower, leaf blower, chain saw, or drill; gardening or yard tools such as a shovel, hoe, plow, or rake; heavy equipment such as a generator, chains, beams, dowels, tires; tools such as hammers, handsaws, wagons, ladders; sporting goods such as bikes, surfboards, kayaks, paddleboards; materials such as bags of dirt, bags of cement mix, cans of paint; or items such as coolers, picnic baskets, lanterns, luggage, speakers, coils of hoses, cables, ropes, bundles of pipes, or rods. The skilled artisan will appreciate all the many weighted objects which can be hung up and supported by the apparatus disclosed herein.

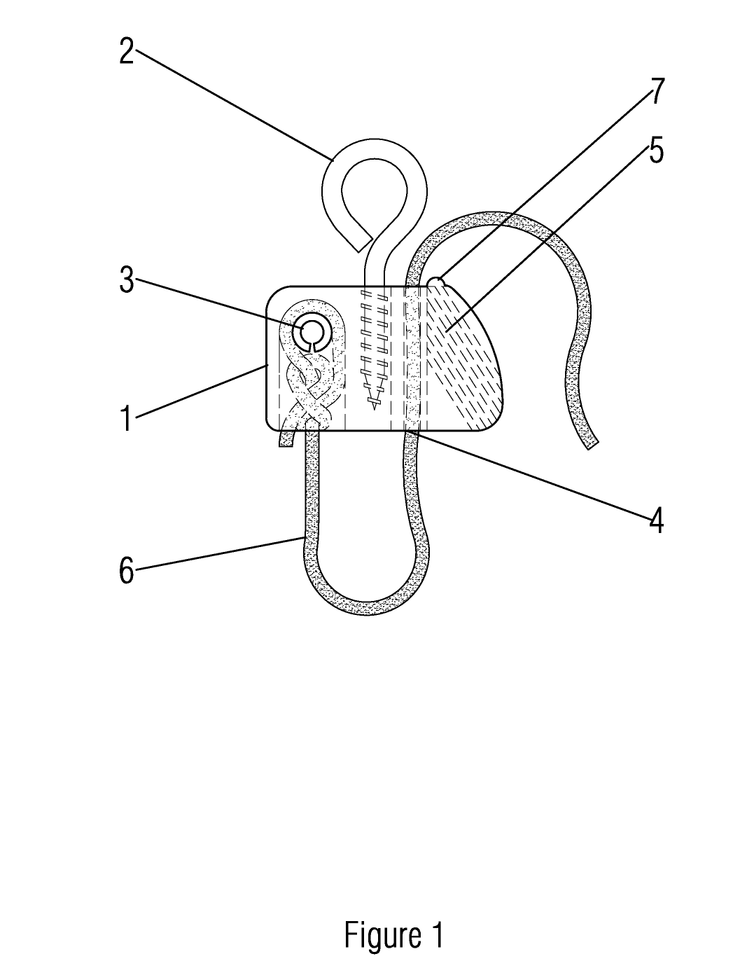

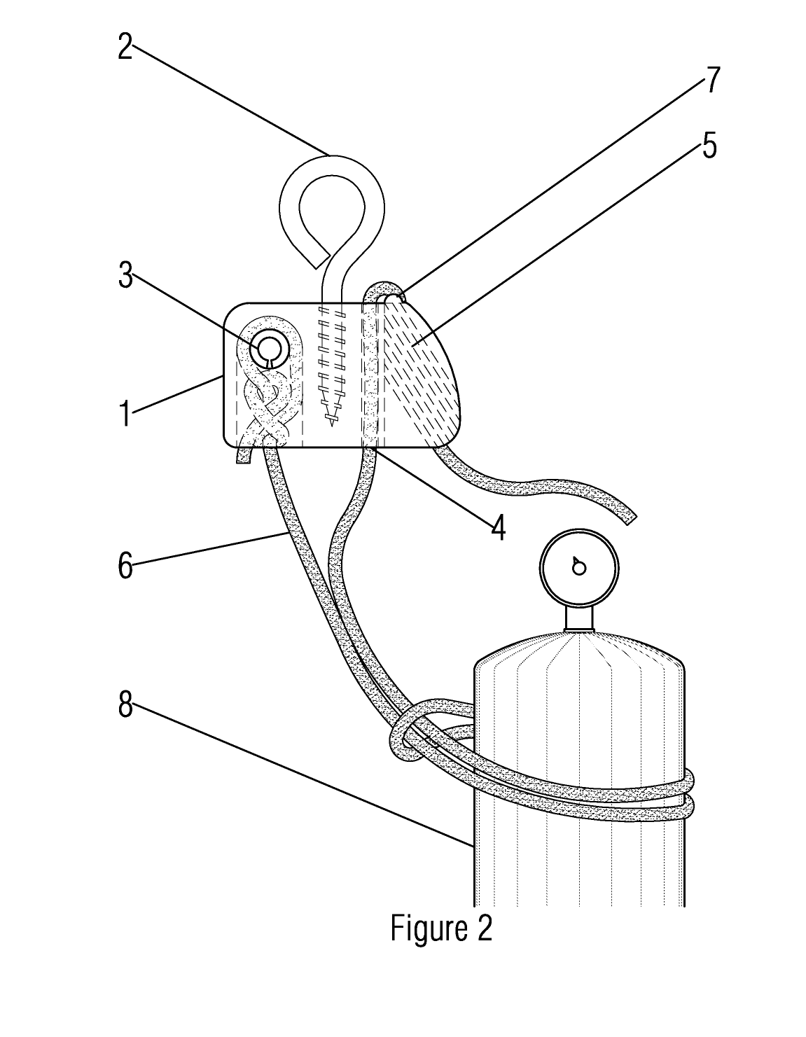

Exemplary embodiments of the present invention are depicted in FIGS. 1-2.

FIG. 1 shows a perspective view of an embodiment of the apparatus disclosed herein. An apparatus for hanging up and supporting a weighted object comprises a central support piece 1 comprising a hanging, device, such as a closed hook 2, an anchoring device, as a tension pin 3, an aperture 4; a cord lock system such as a notched groove lock 5; and an elongate cord 6. In one embodiment, the apparatus disclosed herein is capable of hanging up and supporting a weighted object when the elongate cord 6 is operably attached to the tension pin 3, returned through the aperture 4 over top the rounded protuberance 7, and secured in the notched groove lock 5.

FIG. 2 shows a perspective view of an embodiment of the apparatus disclosed herein hanging up and supporting a weighted object. In the illustration, the exemplary weighted object is a fire extinguisher 8. In one embodiment, the apparatus is capable of hanging up and supporting the fire extinguisher 8 when the elongate cord 6 is operably attached to the tension pin 3 anchoring device; returned through the aperture 4; secured in the notched groove cord lock system 5; and looped around the fire extinguisher 8.

The central support piece 1 of the apparatus disclosed herein is designed to accommodate a hanging device, and an anchoring device. The central support piece is additionally designed to accommodate an elongate cord 6 via an aperture 4 and a cord lock system such as a notched groove lock 5, in such a manner to provide sufficient tensile strength for hanging up and supported weighted objects. In one embodiment, the cord lock system, such as the notched groove lock 5, is configured into the central support piece 1. In another embodiment, the cord lock system may be an internal or external cord lock system. In one embodiment, the notched grooves of the notched groove lock 5 are designed to engage the elongate cord 6 for retention of a weighted object. The size of the notched grooves will depend upon a varying number of factors such as the size of the apparatus, the weighted object, the diameter of the elongate cord, and/or the level of retention desired. In an additional embodiment, the central support piece 1 is designed to include a rounded protuberance 7 located between topside of the aperture 4 and the cord lock system such as the notched groove lock 5. The rounded protuberance 7 may be molded onto or adhered thereto the central support piece 1. A skilled artisan will appreciate that a cord is strongest when not bent. Therefore, the rounded protuberance 7 will prevent the elongate cord 6, exiting topside of the aperture, from bending sharply upon engaging within the notched groove lock 5 system. In this manner, the elongate cord 6 will maintain sufficient tensile strength for hanging up and supporting, a weighted object.

The central support piece 1 can be constructed of a variety of durable composite materials well known in the art. Such materials for example include, without limitation, synthetic fibers of high tensile strength and/or rubber formulations, nylon and/or fiberglass formulations, thermoplastic polyamide and/or polyresin formulations, and nylon polymers or copolymers. Therefore, the skilled artisan will readily appreciate a suitable material or combinations of materials for constructing the central support piece 1 of the present invention.

Hanging devices of the present invention are readily available in the art and relate to any variety of means by which a user can hang up and support an object. Hanging devices of the apparatus disclosed herein and for use with the central support piece 1 thereof include, without limitation, one or more of clip hooks, open hooks, closed hooks 2, eye hooks, swivel hangers, such as but not limited to swivel nuts, swivel loops, swivel hooks, and swivel rings; and/or cords, such as elasticized or non-elasticized cords. Any such hanging device or combination of hanging devices will be operably attached to the central support piece 1 in such a manner as to provide the means by which use the apparatus disclosed herein hangs up and supports a weighted object.

Anchoring devices of the apparatus disclosed herein are readily available in the art and relate to any variety of means through which will increase tensile strength of the apparatus. For example, an anchoring device of the present invention includes, without limitation, one or more of a tension pin 3, such as a spring pin, or a roll pin, a swaged stop, a swaged ferrule, a rod of various materials, a screw, or a bolt. In another embodiment, the anchoring device may be an indentation or protrusion. In a further embodiment, the indentation or protrusion may be molded into the central support piece 1. An anchoring device of the present invention may be an internal anchoring device and as such would be housed or located within the central support piece 1. An anchoring device of die present invention may alternatively be an external anchoring device and as such would be located on (viewable from) the exterior of the central support piece 1. An anchoring device of the apparatus disclosed herein may be operably attached to the elongate cord via a knot. Any knot when properly tied and subjected to tension can be used for operable attachment to the anchoring device herein. For example, such knots are, but not limited to, a buntline hitch or a dead man's knot. These types of knots are very difficult to untie or unknot. The skilled artisan will appreciate that if there is no bend in the elongate cord 6 less than 3 times the diameter of the elongate cord 6, it retains nearly the same strength as a straight cord. Therefore, the anchoring device should be about 3 times the diameter of the elongate cord 6 and there should be no sharp bends before the elongate cord 6 is placed over the anchoring device and tied in the knot at the bottom of the anchoring device.

At least one aperture 4 within the central support piece 1 of the apparatus disclosed herein is designed to be an aperture 4 through which an elongate cord 6 can be guided and engaged within a cord lock system in such a manner so as to increase tensile strength of the apparatus for hanging up and supporting a weighted object. In some embodiments, the central support piece I may comprise two or more apertures. The skilled artisan will readily appreciate that apertures designed to accommodate elongate cords will be holes or openings spanning top to bottom or side to side of the central support piece 1. The at least one aperture or two or more apertures are of a diameter of approximate the same or slightly larger diameter of a particular corresponding elongate cord.

The cord lock system, such as the notched groove lock 5, of the apparatus disclosed herein may be internally located within the central support piece 1 or may be externally located (viewable) on the central support piece 1. In one embodiment, the apparatus disclosed herein comprises a notched groove lock 5 cord lock system which is capable of locking the loose end of an elongate cord 6 after length adjustment. As mentioned above, the size of the notched grooves will depend upon a varying number of factors such as the size of the apparatus, the weighted object, the diameter of the elongate cord, and/or the level of retention desired. The cord lock system of the apparatus disclosed herein may also be selected from any number of varying types and/or combinations of cord lock systems. In one embodiment, the apparatus disclosed herein comprises a cord lock system selected from the group consisting of notched groove lock 5, a cam lock, a wedge lock, a notched rod lock, a compression pin lock, an aperture binding lock, a swaged ferrule lock, and a sliding lock. A skilled artisan will readily appreciate the cord lock systems well known in the art and which may be used for designing a central support piece 1 capable of providing sufficient tensile strength for hanging up and supporting weighted objects. In one embodiment of the apparatus disclosed herein, the cord lock system may be a cam lock. Such a cam lock may have a notched end which jams the elongate cord as weight is suspended on the cord. Such a cam lock may additionally have a protuberance associated therewith for manually releasing the cam lock from the elongate cord. In another embodiment, the cord lock system may be a wedge lock. When a weighted object is suspended from an elongate cord, such a wedge lock will be pulled or wedged into the aperture compressing the elongate cord against the side of the aperture thereby forcing the elongate cord into a locked position. In another embodiment, the cord lock system may be a notched rod lock which slides down on the elongate cord when weighted thereby forcing the elongate cord into a locked position. Such a notched rod lock may be manually lifted or pushed to release the elongate cord to an unlocked position. In another embodiment of the apparatus disclosed herein, cord lock system may be a compression pin lock. Such a compression pin (or rod or bar) will slide loosely in a slot (positioned diagonally, perpendicularly or horizontally in relation to the aperture with the elongate cord). In response to suspended weight, the compression pin will push the elongate cord against the opposite side of the aperture thereby forcing the elongate cord into a locked position. Such a compression pin lock may be manually released by knurled ends or knobs associated therewith the pin, bar or rod. In another embodiment, the cord lock system may be art aperture binding lock wherein the elongate cords will be guided through two or more apertures positioned on the apparatus in such a way to bind and lock the elongate cord. In another embodiment, the cord lock system may be a swaged ferrule positioned either on the central support piece and/or onto the elongate cord in such a manner so as to lock the loose end of the elongate cord with the portion of the elongate cord supporting the weighted object. In another embodiment, the cord lock system may be a sliding lock. Such a sliding lock may incorporate any known sliding mechanism into the central support piece so the sliding mechanism can engage the elongate cord into a locked position.

An elongate cord 6 of the apparatus of the present invention has any desired length which can accommodate and/or be looped around and/or cinched around and span a region around the circumference, width, length, and/or diameter of a particular weighted object or of any extended portion thereof, such as a handle or protruding member.

In some embodiments, the elongate cord 6 of the apparatus disclosed herein is non-elastomeric or a non-elasticized elongate cord which may have no elasticity or limited elasticity. Such an elongate cord may be sheathed or unsheathed. Such a non-elasticized elongate cord may have a cross section that is circular, oval, polygonal or any other desired shape and may be, but not limited to, a height which is 50%, 75%, or 90% of its width. Such a non-elastomeric or non-elasticized elongate cord having no or limited elasticity may consist of materials such as a rope, nylon, polyester, polypropylene or combinations thereof. The skilled artisan will readily appreciate non-elastic and/or limited elastic materials.

In some embodiments, the elongate cord will be an elasticized elongate cord. Such elastic elongate cords have an elastic quality which causes the cord to elongate when a tensile force is present. When a tensile force is not present, the elasticized elongate cord returns to its original length. An elongate cord 6 used in conjunction with the apparatus disclosed herein may have a circular or oval-shaped cross section, such as but not limited to a shock cord or a bungee cord. Such a circular cross section may contribute to uninhibited rotation of the cord when connected to the apparatus of the present invention; whereas an oval-shaped cross section may contribute to an inhibited rotation of the cord when connected to the apparatus of the present invention. An elongate cord having polygonal or otherwise shaped cross sections may also be used. The elongate cord may have a cross section which has a height of, but not limited to, about 50%, 75%, or 90% of its width. Elongate cords to be used with the present invention may be made from a variety of different materials or combinations of materials, depending on the size of the apparatus, the weighted object to be hung and/or supported; as well as the intended use of the apparatus. Such materials may provide the desired level of elasticity, tensile strength, potential durability, and/or combinations thereof. In some embodiments, the materials of the elongate cord will be readily appreciated by the skilled artisan and may be made from polymers, rubber, rubber-like material, and/or other elastomeric material. In some embodiments, the elongate cord of the apparatus disclosed herein consists of a single strand of elastomeric material. In some embodiments, the elongate cord of the apparatus disclosed herein consists of a variety of strands of elastomeric material to achieve desired tensile strength and elastic capabilities.

In some embodiments, the elongate cord 6 of the apparatus disclosed herein is encompassed by a sheath covering the non-elasticized or elasticized material. Such a sheath would consist of a material which would have the ability to elongate relative to the elongate cord. Such a sheath may be adhered to or woven onto the elongate cord. Such a sheath may make more durable and/or protect and/or lengthen the life-span of an elongate cord. In some embodiments, the sheath thickness is relative to the notched groove lock of the apparatus disclosed herein. A sheath may be configured so that the cord lock system; e.g., the notched grooves of the notched groove lock 5 engage the sheath with or without puncture depending upon various factors such as the size of the apparatus, the weighed object and/or the level of retention desired.

Without departing from the scope and spirit of the present invention, reasonable features, modifications, advantages, and design variations of the claimed apparatus will become readily apparent to those skilled in the art by following the guidelines set forth in the preceding detailed description and embodiments.

What is claimed:

1. An apparatus for hanging, up and supporting a weighted object; the apparatus comprising a central support piece comprising:
a hanging device,
an anchoring device,
an aperture; and
a cord lock system; wherein the apparatus is capable of hanging up and supporting a weighted object when an elongate cord is
attached to the anchoring device,
returned through the aperture,
secured in the cord lock system, and
looped around the weighted object.

2. The apparatus of claim 1, further comprising an elongate cord, wherein the elongate cord is attached to the anchoring device and returned through the aperture.

3. The apparatus of claim 2, wherein the elongate cord is secured in the cord lock system and looped around the weighted object.

4. The apparatus of claim 2, wherein the elongate cord is a non-elasticized elongate cord.

5. The apparatus of claim 2, wherein the elongate cord is attached to the anchoring device via a knot.

6. The apparatus of claim 5, wherein the knot is a buntline hitch.

7. The apparatus of claim 1, wherein the hanging device is selected from the group consisting of a clip hook, an open hook, a closed hook, an eye hook, a swivel hanger, and a cord.

8. The apparatus of claim 1, wherein the weighted object is an object with a pound-mass up to about 150 pounds (lbs).

9. The apparatus of claim 1, wherein the anchoring device is selected from the group consisting of a tension pin, a swaged stop, and a swaged ferrule.

10. The apparatus of claim 9, wherein the anchoring device is a tension pin.

11. The apparatus of claim 10, wherein the tension pin is an internal tension pin.

12. The apparatus of claim 10, wherein the tension pin is a spring pin or a roll pin.

13. The apparatus of claim 1, wherein the anchoring device is an indentation or protrusion on the central support piece.

14. The apparatus of claim 1, wherein the cord lock system is an external cord lock system.

15. The apparatus of claim 1, wherein the cord lock system is selected from the group consisting of a notched groove lock, a cam lock, a wedge lock, a notched rod lock, a compression pin lock, an aperture binding lock, a swaged ferrule lock, and a sliding lock.

16. The apparatus of claim 1, wherein the cord lock system is a notched groove lock.

17. The apparatus of claim 1, fluffier comprising a rounded protuberance at topside of the aperture.

18. The apparatus of claim 15, wherein the rounded protuberance is molded onto the central support piece.

19. An apparatus for hanging up and supporting a weighted object; the apparatus comprising a central support piece comprising:
a hanging device,
an anchoring device,
an aperture;
a cord lock system; and
an elongate cord; wherein the elongate cord is attached to the anchoring device; and wherein the apparatus is capable of hanging up and supporting a weighted object when the elongate cord is
returned through the aperture,
secured in the cord lock system, and
looped around the weighted object.

20. The apparatus of claim 17, wherein the elongate cord is returned through the aperture, secured in the cord lock system, and looped around the weighted object.
